(19) United States
(12) Patent Application Publication
(10) Pub. No.: US 2021/0043084 A1
(43) Pub. Date: Feb. 11, 2021

(54) COMPUTER-READABLE RECORDING MEDIUM, CONTROL DEVICE, SYSTEM, DEVICE, AND VEHICLE

(71) Applicant: Toyota Jidosha Kabushiki Kaisha, Toyota-shi (JP)

(72) Inventor: Daiki Kaneichi, Nisshin-shi (JP)

(73) Assignee: Toyota Jidosha Kabushiki Kaisha, Toyota-shi (JP)

(21) Appl. No.: 16/877,792

(22) Filed: May 19, 2020

(30) Foreign Application Priority Data
Aug. 9, 2019 (JP) 2019-147411

(51) Int. Cl. G08G 1/0968

(52) U.S. Cl. CPC G08G 1/096816; G08G 1/096861

(57) ABSTRACT

A communication device includes: a communication unit configured to communicate with a control device that notifies a device of a vehicle which is boarded by a user of a destination which is set by the user; and a control unit configured to transmit first data for notifying of the destination along with a user identifier corresponding to the user to the control device via the communication unit, to acquire a vehicle identifier corresponding to the vehicle in accordance with the user's operation, and to transmit second data for notifying of the vehicle identifier along with the user identifier to the control device via the communication unit.

### CROSS-REFERENCE TO RELATED APPLICATION

This application claims priority to Japanese Patent Application No. 2019-147411 filed on Aug. 9, 2019, the entire contents of which are incorporated herein by reference in its entirety.

### BACKGROUND

### 1. Technical Field

The present disclosure relates to a computer-readable recording medium, a control device, a system, a device, and a vehicle.

### 2. Description of Related Art

Japanese Patent Application Publication No. 2004-341872 (JP 2004-341872 A) discloses a technique of making a reservation for allocation of a taxi based on request information including information of a destination which is input by a user via a terminal installed in a store or a facility.

### SUMMARY

In the technique described in JP 2004-341872 A, an inquiry about whether a vehicle is to be allocated, which includes information of a destination input by a user, is transmitted to a taxi, but it is not clear that the information is to be used for setting a destination in the taxi. Since a reservation for allocation of a vehicle is necessary, it is not possible to use information of a destination input by a user for setting a destination in an unreserved taxi such as a cruising taxi.

The disclosure provides a technique of using information of a destination which is set by a user for setting a destination in a vehicle which is boarded by the user.

According to the disclosure, there is provided a computer-readable recording medium storing a program causing a computer to serve as a communication device including: a communication unit configured to communicate with a control device that notifies a device of a vehicle which is boarded by a user of a destination which is set by the user; and a control unit configured to transmit first data for notifying of the destination along with a user identifier corresponding to the user to the control device via the communication unit, to acquire a vehicle identifier corresponding to the vehicle in accordance with the user's operation, and to transmit second data for notifying of the vehicle identifier along with the user identifier to the control device via the communication unit.

According to the disclosure, there is provided a control device including: a communication unit configured to communicate with devices of a plurality of vehicles and a communication device of a user; and a control unit configured to receive first data for notifying of a destination set by the user along with a user identifier corresponding to the user from the communication device via the communication unit, to receive second data for notifying of a vehicle identifier corresponding to a vehicle which is boarded by the user along with the user identifier from the communication device that has acquired the vehicle identifier via the communication unit, and to transmit destination data for notifying of the destination to the device of the vehicle corresponding to the vehicle identifier via the communication unit with reference to the first data and the second data which commonly include the user identifier.

According to the disclosure, there is provided a computer-readable recording medium storing a program causing a computer to serve as a device which is used for a vehicle, the device including: a communication unit configured to communicate with a control device that receives first data for notifying of a destination which is set by a user who has boarded the vehicle along with a user identifier corresponding to the user; and a control unit configured to cause a communication device that transmits the first data to the control device to acquire a vehicle identifier corresponding to the vehicle in accordance with the user's operation of the communication device and to receive destination data for notifying of the destination, which is transmitted as a result of transmission of second data for notifying of the vehicle identifier along with the user identifier from the communication device to the control device and reference of the first data and the second data commonly including the user identifier by the control device, from the control device via the communication unit.

According to the disclosure, it is possible to use information of a destination which is set by a user for setting a destination in a vehicle which is boarded by the user.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of a system according to an embodiment;

FIG. 2 is a block diagram illustrating a configuration of a communication device according to the embodiment;

FIG. 3 is a block diagram illustrating a configuration of a control device according to the embodiment;

FIG. 4 is a block diagram illustrating a configuration of a device according to the embodiment;

FIG. 5 is a diagram illustrating an operation of the system according to the embodiment;

FIG. 6 is a diagram illustrating an operation of the system according to the embodiment; and

FIG. 7 is a diagram illustrating an example of a screen of a terminal according to the embodiment.

### DETAILED DESCRIPTION OF EMBODIMENTS

Hereinafter, an embodiment will be described with reference to the accompanying drawings.

In the drawings, the same or corresponding elements will be referred to by the same reference signs. In description of embodiments, description of the same or corresponding elements will be appropriately omitted or simplified.

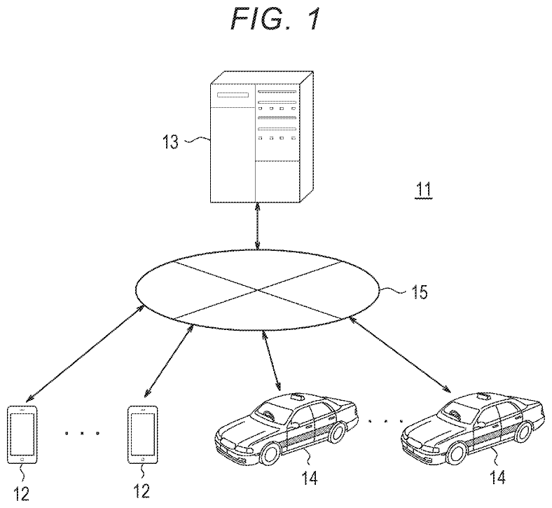

The configuration of a system 11 according to this embodiment will be described below with reference to FIG. 1.

The system 11 according to this embodiment includes a plurality of terminals 12, at least one server 13, and a plurality of vehicles 14.

Each terminal 12 can communicate with the server 13 via a network 15 such as a mobile communication network or the Internet. Each terminal 12 may communicate with other terminals 12 via the network 15. Each terminal 12 may communicate with the vehicles 14 via the network 15.

The server 13 can communicate with the vehicles 14 as well as the terminals 12 via the network 15.

Each vehicle 14 is a taxi in this embodiment, but they may be vehicles other than taxis, such as on-demand buses, as long as they can pick up users. Each vehicle 14 is an arbitrary type of vehicle such as a gasoline vehicle, a diesel vehicle, an HV, a PHV, an EV, or an FCV. “HV” is an abbreviation for “hybrid vehicle.” “PHV” is an abbreviation for “plug-in hybrid vehicle.” “EV” is an abbreviation for “electric vehicle.” “FCV” is an abbreviation for “fuel cell vehicle.” Each vehicle 14 is driven by a driver in this embodiment, but driving may be automated at an arbitrary level. An automation level is, for example, one of levels 1 to 5 in level classifications of SAE. “SAE” is an abbreviation for “Society of Automotive Engineers.” Each vehicle 14 may be an MaaS-dedicated vehicle. “MaaS” is an abbreviation for “mobility as a service.”

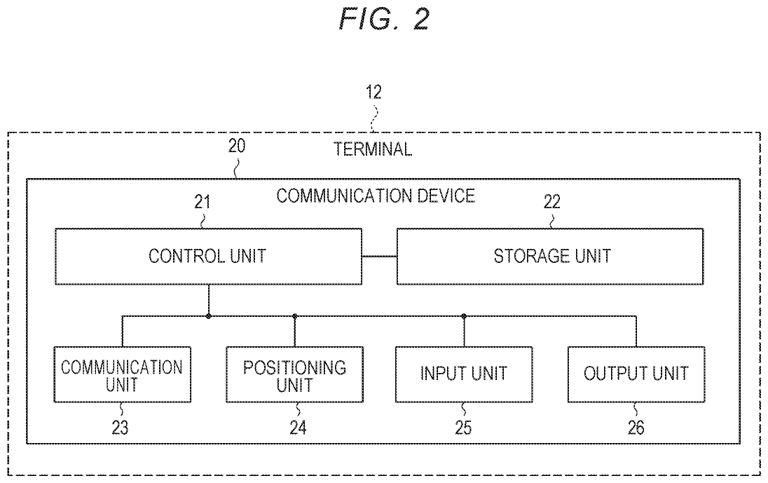

An outline of this embodiment will be described below with reference to FIGS. 2, 3, and 4.

A communication device 20 which is constituted as each terminal 12 transmits first data for notifying of a destination set by a user along with a user identifier corresponding to the user to a control device 30 which is constituted as a server 13. For example, the communication device 20 which is constituted as a terminal 12 of a user U1 transmits first data for notifying of a destination set by the user U1 along with a user identifier “U1” corresponding to the user U1 to the control device 30 which is constituted as the server 13. The control device 30 receives the first data from the communication device 20.

The communication device 20 acquires a vehicle identifier corresponding to a vehicle 14 which is boarded by a user in accordance with the user's operation. The communication device 20 transmits second data for notifying of the acquired vehicle identifier along with the user identifier corresponding to the user to the control device 30. For example, the communication device 20 which is constituted as a terminal 12 of a user U1 acquires a vehicle identifier “V1” corresponding to a vehicle V1 which is boarded by the user U1 in accordance with the user U1's operation. The communication device 20 transmits second data for notifying of the vehicle identifier “V1” along with the user identifier “U1” to the control device 30. The control device 30 receives the second data from the communication device 20.

The control device 30 transmits destination data for notifying of a destination to a device 40 which is used in the vehicle 14 with reference to the first data and the second data commonly including a user identifier. For example, the control device 30 transmits destination data for notifying of a destination to a device 40 which is used in the vehicle V1 corresponding to the vehicle identifier “V1” with reference to the first data and the second data commonly including a user identifier “U1.” The device 40 of the vehicle 14 receives the destination data from the control device 30.

According to this embodiment, information of a destination which is set by a user can be used to set a destination in a vehicle 14 which is boarded by the user. For example, the device 40 of the vehicle V1 can set a destination for car navigation using information of the destination for multimodal navigation which is input to the terminal 12 of a user U1 by the user U1. “Multimodal navigation” is to guide for a multimodal route. A “multimodal route” is a route in which various moving means such as walk, a bicycle, a bus, a rented vehicle, a private vehicle, a taxi, a railroad, and an airplane are combined. The multimodal route may include a route in which a taxi as the vehicle 14 is used.

In this embodiment, the control device 30 determines a route to a destination based on position information of a user. The control device 30 transmits route data for notifying of the determined route to the communication device 20. The communication device 20 receives the route data from the control device 30. The communication device 20 guides the user for the route to the destination with reference to the received route data. Transmission of the route data from the control device 30 to the communication device 20 is performed before transmission of destination data to the device 40 of the vehicle 14. That is, the communication device 20 receives route data from the control device 30 and guides the user for the route to the destination based on position information of the user, at least after the destination has been set and before an operation for a boarding procedure is performed. Instead of the control device 30, the communication device 20 may determine the route for which the user is guided.

The “operation for a boarding procedure” is an operation of acquiring a vehicle identifier corresponding to the vehicle 14 which is boarded by the user. Examples of such an operation include an operation of causing a camera of the terminal 12 to face a display that displays a vehicle identifier in the vehicle V1 and an operation of holding a tag of the terminal 12 up to a reader writer that transmits a vehicle identifier in the vehicle V1.

In this embodiment, the control device 30 determines a route to a destination based on position information of the vehicle 14 after the operation for a boarding procedure has been performed. The control device 30 transmits route data for notifying of the determined route to the device 40 of the vehicle 14. The device 40 of the vehicle 14 receives the route data from the control device 30. The device 40 of the vehicle 14 guides a driver of the vehicle 14 for the route to the destination with reference to the received route data. That is, the device 40 of the vehicle 14 guides the driver of the vehicle 14 for the route to a destination based on the position information of the vehicle 14 after the operation for a boarding procedure has been performed. Instead of the control device 30, the device 40 of the vehicle 14 may determine the route for which the driver of the vehicle 14 is guided.

According to this embodiment, a navigation function which is used by a user when the user is not in the vehicle 14 and a navigation function which is used by a driver of the vehicle 14 when the user is in the vehicle 14 can be linked. For example, an application for car navigation operating in the device 40 of the vehicle V1 which is boarded by a user U1 succeeds to information of a destination from an application for multimodal navigation operating in the terminal 12 of the user U1 via the server 13.

The configuration of the communication device 20 according to this embodiment will be described below with reference to FIG. 2.

The communication device 20 is constituted as one terminal 12 in this embodiment. That is, the communication device 20 is provided in the system 11 according to this embodiment for each terminal 12. The communication device 20 is, for example, a mobile phone, a smartphone, a tablet, or a PC. “PC” is an abbreviation for personal computer.

The communication device 20 includes a control unit 21, a storage unit 22, a communication unit 23, a positioning unit 24, an input unit 25, and an output unit 26.

The control unit 21 includes one or more processors, one or more dedicated circuits, or a combination thereof. The processor is a general-purpose processor such as a CPU or a dedicated processor specialized in a specific process. “CPU” is an abbreviation for central processing unit. Examples of the dedicated circuit include FPGA and ASIC. “FPGA” is an abbreviation for field-programmable gate array. “ASIC” is an abbreviation for application specific integrated circuit. The control unit 21 may control constituent units of the communication device 20 and performs processes associated with the operation of the communication device 20.

The storage unit 22 includes one or more semiconductor memories, one or more magnetic memories, one or more optical memories, or a combination of at least two types thereof. Examples of the semiconductor memory include a RAM or a ROM. “RAM” is an abbreviation for random access memory. “ROM” is an abbreviation for read only memory. Examples of the RAM include an SRAM and a DRAM. “SRAM” is an abbreviation for static random access memory. “DRAM” is an abbreviation for dynamic random access memory. An example of the ROM is an EEPROM. “EEPROM” is an abbreviation for electrically erasable programmable read only memory. The storage unit 22 serves as, for example, a main storage device, an auxiliary storage device, or a cache storage device. The storage unit 22 stores data which is used for the operation of the communication device 20 and data which is acquired through the operation of the communication device 20.

The communication unit 23 includes one or more communication interfaces. The communication interface is, for example, an interface corresponding to a mobile communication standard such as LTE, 4G, or 5G, an interface corresponding to short-range radio communication such as Bluetooth (registered trademark), or an LAN interface. “LTE” is an abbreviation for Long Term Evolution. “4G” is an abbreviation for 4-th generation. “5G” is an abbreviation for 5-th generation. “LAN” is an abbreviation for local area network. The communication unit 23 receives data which is used for the operation of the communication device 20 and transmits data which is acquired through the operation of the communication device 20.

The positioning unit 24 includes one or more GNSS receivers. “GNSS” is an abbreviation for Global Navigation Satellite System. For example, GNSS includes at least one of GPS, QZSS, GLONASS, or Galileo. “GPS” is an abbreviation for global positioning system. “QZSS” is an abbreviation for quasi-zenith satellite system. A satellite of the QZSS is called as a quasi-zenith satellite. “GLONASS” is an abbreviation for global navigation satellite system. The positioning unit 24 acquires position information of the terminal 12 as position information of a user.

The input unit 25 includes one or more input interfaces. Examples of the input interface include a physical key, a capacitive key, a pointing device, a touch screen which is incorporated into a display, a microphone, a camera, or a tag corresponding to NFC. “NFC” is an abbreviation for near-field communication. The input unit 25 receives an operation of inputting data which is used for the operation of the communication device 20.

The output unit 26 includes one or more output interfaces. Examples of the output interface include a display and a speaker. Examples of the display include an LCD or an organic EL display. “LCD” is an abbreviation for liquid crystal display. “EL” is an abbreviation for “electroluminescence.” The output unit 26 outputs data which is acquired through the operation of the communication device 20.

The function of the communication device 20 is realized by causing a processor included in the control unit 21 to execute a communication program according to this embodiment. That is, the function of the communication device 20 is realized in software. The communication program is a program for causing a computer to realize functions corresponding to processes of steps included in the operation of the communication device 20 by causing the computer to perform the processes of steps. That is, the communication program is a program for causing a computer to serve as the communication device 20.

A program can be recorded on a computer-readable recording medium. For example, a magnetic recording medium, an optical disk, a magneto-optical recording medium, or a semiconductor memory can be used as the computer-readable recording medium. Distribution of the program is performed, for example, by selling, transferring, or renting a portable recording medium such as a DVD or a CD-ROM on which the program is recorded. “DVD” is an abbreviation for digital versatile disc. “CD-ROM” is an abbreviation for compact disc read only memory. The program may be distributed by storing the program in a storage of a server and transmitting the program from the server to another computer. The program may be provided as a program product.

A computer temporarily stores, for example, a program recorded on a portable recording medium or a program transmitted from the server in a main storage device. The computer reads the program stored in the main storage device using a processor and causes the processor to perform processes based on the read program. The computer may read a program directly from a portable recording medium and perform processes based on the read program. The computer may sequentially perform processes based on the received program when the program is transmitted from the server to the computer. Instead of transmitting a program from the server to the computer, the processes may be performed by a so-called ASP type service of realizing functions through only execution instruction and result acquisition. “ASP” is an abbreviation for application service provider. The program includes information which is provided for processing in a computer and which is equivalent to a program. For example, data which is not a direct command for a computer but has characteristics defining processes of a computer corresponds to “information equivalent to a program.”

Some or all functions of the communication device 20 may be realized by a dedicated circuit included in the control unit 21. That is, some or all functions of the communication device 20 may be realized in hardware.

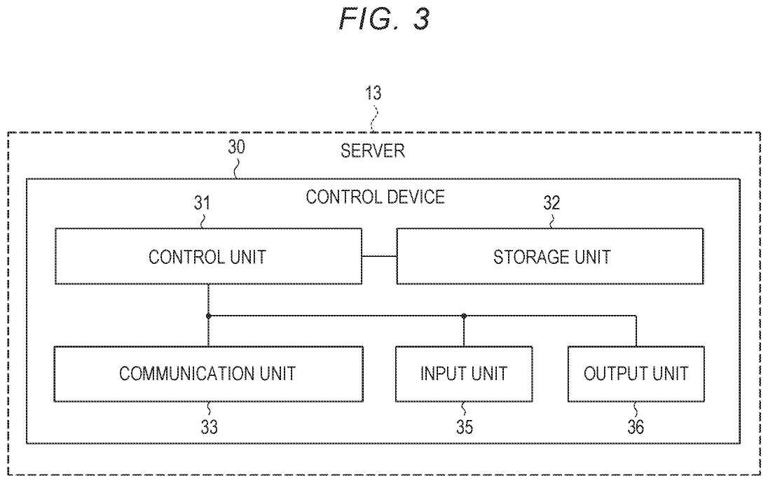

The configuration of the control device 30 according to this embodiment will be described below with reference to FIG. 3.

The control device 30 is constituted as a server 13 in this embodiment. That is, the control device 30 is provided as the server 13 in the system 11 according to this embodiment. For example, the server 13 is a server which belongs to a cloud computing system or other computing systems.

The control device 30 includes a control unit 31, a storage unit 32, a communication unit 33, an input unit 35, and an output unit 36.

The control unit 31 includes one or more processors, one or more dedicated circuits, or a combination thereof. The processor is a general-purpose processor such as a CPU or a dedicated processor specialized in a specific process. Examples of the dedicated circuit include FPGA and ASIC. The control unit 31 may control constituent units of the control device 30 and performs processes associated with the operation of the control device 30.

The storage unit 32 includes one or more semiconductor memories, one or more magnetic memories, one or more optical memories, or a combination of at least two types thereof. Examples of the semiconductor memory include a RAM and a ROM. Examples of the RAM include an SRAM and a DRAM. An example of the ROM is an EEPROM. The storage unit 32 serves as, for example, a main storage device, an auxiliary storage device, or a cache storage device. The storage unit 32 stores data which is used for the operation of the control device 30 and data which is acquired through the operation of the control device 30.

The communication unit 33 includes one or more communication interfaces. The communication interface is, for example, a LAN interface. The communication unit 33 receives data which is used for the operation of the control device 30 and transmits data which is acquired through the operation of the control device 30.

The input unit 35 includes one or more input interfaces. Examples of the input interface include a physical key, a capacitive key, a pointing device, a touch screen which is incorporated into a display, and a microphone. The input unit 35 receives an operation of inputting data which is used for the operation of the control device 30.

The output unit 36 includes one or more output interfaces. Examples of the output interface include a display and a speaker. Examples of the display include an LCD or an organic EL display. The output unit 36 outputs data which is acquired through the operation of the control device 30.

The function of the control device 30 is realized by causing a processor included in the control unit 31 to execute a control program according to this embodiment. That is, the function of the control device 30 is realized in software. The control program is a program for causing a computer to realize functions corresponding to processes of steps included in the operation of the control device 30 by causing the computer to perform the processes of steps. That is, the control program is a program for causing a computer to serve as the control device 30.

Some or all functions of the control device 30 may be realized by a dedicated circuit included in the control unit 31. That is, some or all functions of the control device 30 may be realized in hardware.

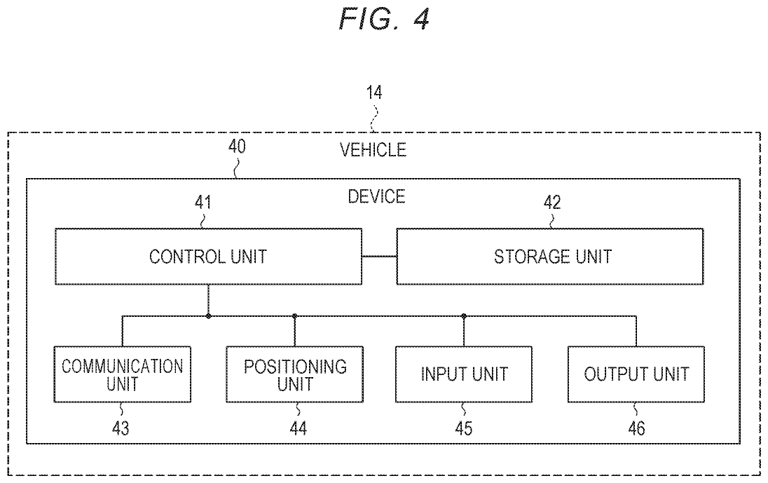

The configuration of the device 40 according to this embodiment will be described below with reference to FIG. 4.

The device 40 is mounted in the vehicle 14 for use in this embodiment. Examples of the device 40 include a mobile phone, a smartphone, a tablet, a PC, and a car navigation device.

The device 40 includes a control unit 41, a storage unit 42, a communication unit 43, a positioning unit 44, an input unit 45, and an output unit 46.

The control unit 41 includes one or more processors, one or more dedicated circuits, or a combination thereof. The processor is a general-purpose processor such as a CPU or a dedicated processor specialized in a specific process. Examples of the dedicated circuit include FPGA and ASIC. The control unit 41 may control constituent units of the device 40 and performs processes associated with the operation of the device 40.

The storage unit 42 includes one or more semiconductor memories, one or more magnetic memories, one or more optical memories, or a combination of at least two types thereof. Examples of the semiconductor memory include a RAM and a ROM. Examples of the RAM include an SRAM and a DRAM. An example of the ROM is an EEPROM. The storage unit 42 serves as, for example, a main storage device, an auxiliary storage device, or a cache storage device. The storage unit 42 stores data which is used for the operation of the device 40 and data which is acquired through the operation of the device 40.

The communication unit 43 includes one or more communication interfaces. The communication interface is, for example, an interface corresponding to a mobile communication standard such as LTE, 4G, or 5G or an interface corresponding to short-range radio communication such as Bluetooth (registered trademark). The communication unit 43 receives data which is used for the operation of the device 40 and transmits data which is acquired through the operation of the device 40.

The positioning unit 44 includes one or more GNSS receivers. For example, GNSS includes at least one of GPS, QZSS, GLONASS, or Galileo. The positioning unit 44 acquires position information of the vehicle 14.

The input unit 45 includes one or more input interfaces. Examples of the input interface include a physical key, a capacitive key, a pointing device, a touch screen which is incorporated into a display, and a microphone. The input unit 45 receives an operation of inputting data which is used for the operation of the device 40.

The output unit 46 includes one or more output interfaces. Examples of the output interface include a display and a speaker. Examples of the display include an LCD or an organic EL display. The output unit 46 outputs data which is acquired through the operation of the device 40.

The function of the device 40 is realized by causing a processor included in the control unit 41 to execute a device program according to this embodiment. That is, the function of the device 40 is realized in software. The device program is a program for causing a computer to realize functions corresponding to processes of steps included in the operation of the device 40 by causing the computer to perform the processes of steps. That is, the device program is a program for causing a computer to serve as the device 40.

Some or all functions of the device 40 may be realized by a dedicated circuit included in the control unit 41. That is, some or all functions of the device 40 may be realized in hardware.

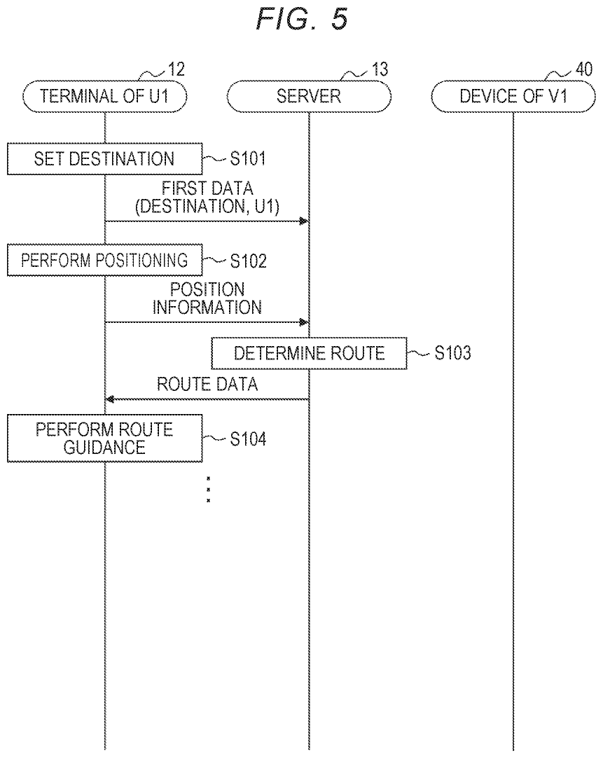

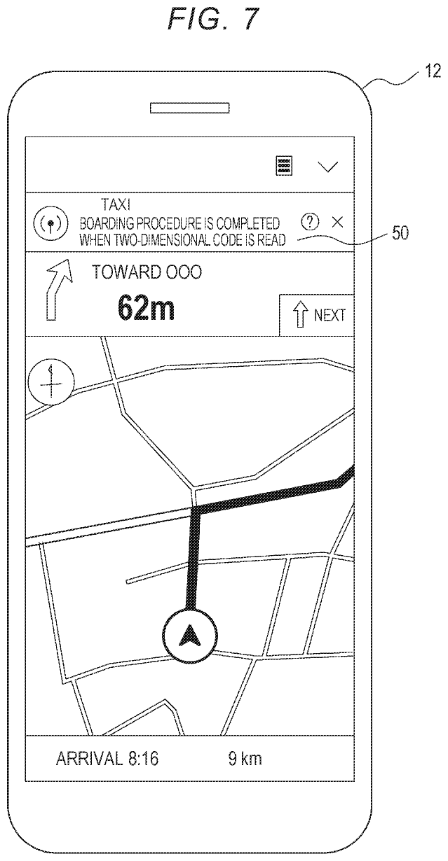

The operation of the system 11 according to this embodiment will be described below with reference to FIGS. 5, 6, and 7. This operation corresponds to a cooperation method according to this embodiment. FIG. 7 illustrates an example of a screen of a terminal 12.

For example, it is assumed that a user U1 starts an application for multimodal navigation using a terminal 12 of the user U1.

In Step S101, the control unit 21 of the communication device 20 corresponding to the terminal 12 of the user U1 receives an operation of the user U1 for setting a destination via the input unit 25. The control unit 21 generates first data for notifying of the destination set by the user U1 along with a user identifier “U1” corresponding to the user U1. The control unit 21 stores the generated first data in the storage unit 22. The control unit 21 transmits the first data stored in the storage unit 22 to the control device 30 corresponding to the server 13 via the communication unit 23.

In this example, the user U1 sets a destination for multimodal navigation in the application for multimodal navigation operating in the terminal 12. The control unit 21 of the terminal 12 notifies the server 13 of the set destination along with the user identifier “U1.”

In Step S102, the control unit 21 of the communication device 20 corresponding to the terminal 12 of the user U1 acquires position information of the user U1 via the positioning unit 24. The control unit 21 stores the acquired position information of the user U1 in the storage unit 22. The control unit 21 transmits the position information of the user U1 stored in the storage unit 22 to the control device 30 corresponding to the server 13 via the communication unit 23.

In this example, the control unit 21 of the terminal 12 acquires two-dimensional coordinates or three-dimensional coordinates of the current position of the user U1 as the position information of the user U1. The control unit 21 transmits the acquired position information of the user U1 along with the user identifier “U1” to the server 13.

In Step S103, the control unit 31 of the control device 30 corresponding to the server 13 receives the first data transmitted in Step S101 and the position information of the user U1 transmitted in Step S102 from the communication device 20 corresponding to the terminal 12 of the user U1 via the communication unit 33. The control unit 31 stores the received first data and the received position information in the storage unit 32. The control unit 31 determines a route to the destination indicated by the first data stored in the storage unit 32 based on the position information of the user U1 stored in the storage unit 32. The control unit 31 stores route data for notifying of the determined route in the storage unit 32. The control unit 31 transmits the route data stored in the storage unit 32 to the communication device 20 via the communication unit 33.

In this example, the control unit 31 of the server 13 calculates a multimodal route which departs from a point corresponding to the position information of the user U1 transmitted along with the user identifier “U1” from the terminal 12 and arrives at the destination transmitted along with the user identifier “U1” from the terminal 12 with reference to map information which is stored in advance in the storage unit 32. The control unit 31 notifies the terminal 12 of the calculated multimodal route.

In Step S104, the control unit 21 of the communication device 20 corresponding to the terminal 12 of the user U1 receives the route data transmitted in Step S103 from the control device 30 corresponding to the server 13 via the communication unit 23. The control unit 21 stores the received route data in the storage unit 22. The control unit 21 performs control such that guidance along the route indicated by the route data stored in the storage unit 22 is performed for the user U1. With this control, the output unit 26 of the communication device 20 guides the user U1 for the route to the destination set by the user U1 on the screen.

In this example, the control unit 21 of the terminal 12 displays the multimodal route transmitted from the server 13 on the screen of the application for multimodal navigation operating in the terminal 12.

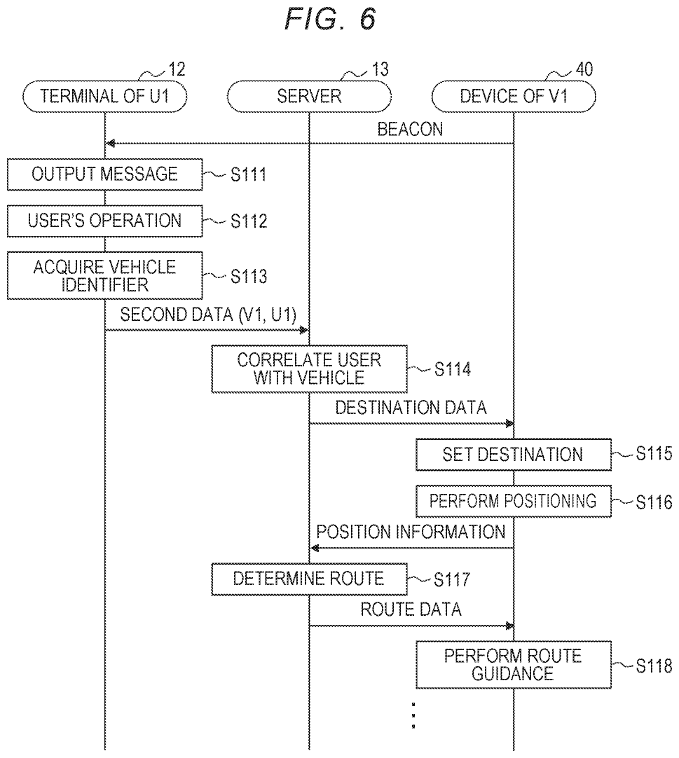

The processes of Steps S102 to S104 are repeatedly performed at least after the destination has been set in Step S101 and before the process of Step S112 in FIG. 6 is performed. The processes of Steps S102 to S104 may be stopped or ended with an arbitrary trigger such as stopping or ending of the application for multimodal navigation.

In Step S111, the communication unit 23 of the communication device 20 corresponding to the terminal 12 of the user U1 receives a beacon which is transmitted in the vehicle V1 which is boarded by the user U1. The beacon may be transmitted and received in an arbitrary communication manner and is transmitted and received, for example, by Bluetooth (registered trademark). When a beacon is received by the communication unit 23, the control unit 21 of the communication device 20 performs control such that a message 50 for prompting the user U1 to perform an operation is output as illustrated in FIG. 7. With this control, the output unit 26 of the communication device 20 outputs the message 50 for prompting the user U1 to perform an operation for a boarding procedure.

In this example, the control unit 21 of the terminal 12 displays an icon indicating that a beacon has been received and a text message of “a boarding procedure is completed when a two-dimensional code is read!” on the screen of the application for multimodal navigation operating in the terminal 12 as illustrated in FIG. 7.

In this embodiment, the communication unit 43 of the device 40 which is used in the vehicle V1 transmits a beacon for prompting the user U1 to perform an operation for a boarding procedure in the vehicle V1, but another device may transmit a beacon for prompting the user U1 to perform an operation for a boarding procedure in the vehicle V1.

In Step S112, the communication device 20 corresponding to the terminal 12 of the user U1 is operated by the user U1.

In this example, the user U1 directs the camera of the terminal 12 to the display on which a vehicle identifier “V1” is displayed in the vehicle V 1. In a modified example, the user U1 may hold a tag of the terminal 12 up to a reader writer that transmits the vehicle identifier “V1” in the vehicle V1.

In Step S113, the control unit 21 of the communication device 20 corresponding to the terminal 12 of the user U1 acquires the vehicle identifier “V1” corresponding to the vehicle V1 in accordance with the user U1's operation in Step S112. The control unit 21 generates second data for notifying of the acquired vehicle identifier “V1” along with the user identifier “U1.” The control unit 21 stores the generated second data in the storage unit 22. The control unit 21 transmits the second data stored in the storage unit 22 to the control device 30 corresponding to the server 13 via the communication unit 23.

In this example, the control unit 21 of the terminal 12 acquires the vehicle identifier “V1” by performing control such that the vehicle identifier “V1” displayed in the vehicle V1 is imaged. Specifically, the control unit 21 acquires the vehicle identifier “V1” by performing control such that the vehicle identifier “V1” displayed as a two-dimensional code is imaged with a camera. In a modified example, the control unit 21 may acquire the vehicle identifier “V1” by performing control such that the vehicle identifier “V1” transmitted in the vehicle V1 is received. Specifically, the control unit 21 may acquire the vehicle identifier “V1” by performing control such that the vehicle identifier “V1” transmitted by short-range radio communication is received by the tag. The control unit 21 transmits the acquired vehicle identifier “V1” along with the user identifier “U1” to the server 13.

In this embodiment, the control unit 41 of the device 40 of the vehicle V1 causes the communication device 20 to acquire the vehicle identifier “V1” corresponding to the vehicle V1 in accordance with the user U1's operation, but another device may cause the communication device 20 to acquire the vehicle identifier “V1” corresponding to the vehicle V1 in accordance with the user U1's operation. Specifically, in this embodiment, the control unit 41 causes the communication device 20 to acquire the vehicle identifier “V1” by performing control such that the vehicle identifier “V1” is displayed, but another vehicle may cause the communication device 20 to acquire the vehicle identifier “V1” by performing control such that the vehicle identifier “V1” is displayed. More specifically, in this embodiment, the control unit 41 causes the communication device 20 to acquire the vehicle identifier “V1” by performing control such that the vehicle identifier “V1” is displayed as a two-dimensional code on the display, but another device may cause the communication device 20 to acquire the vehicle identifier “V1” by performing control such that the vehicle identifier “V1” is displayed as a two-dimensional code on the display. In a modified example, the control unit 41 or another device may cause the communication device 20 to acquire the vehicle identifier “V1” by performing control such that the vehicle identifier “V1” is transmitted. Specifically, the control unit 41 may cause the communication device 20 to acquire the vehicle identifier “V1” by performing control such that the vehicle identifier “V1” is transmitted from a writer by short-range radio communication.

In Step S114, the control unit 31 of the control device 30 corresponding to the server 13 receives the second data transmitted in Step S113 from the communication device 20 corresponding to the terminal 12 of the user U1 via the communication unit 33. The control unit 31 stores the received second data in the storage unit 32. The control unit 31 correlates the user U1 and the vehicle V1 with reference to the first data and the second data which commonly include the user identifier “U1” and which are stored in the storage unit 32. The control unit 31 generates destination data for notifying of the destination indicated by the first data. The control unit 31 stores the generated destination data in the storage unit 32. The control unit 31 transmits the destination data stored in the storage unit 32 to the device 40 of the vehicle V1 corresponding to the vehicle identifier “V1” indicated by the second data via the communication unit 33. That is, the control unit 31 transmits the destination data for notifying of the destination set by the user U1 to the device 40 of the vehicle V1 correlated with the user U1.

In this example, the control unit 31 of the server 13 notifies the device 40 of the vehicle V1 corresponding to the vehicle identifier “V1” transmitted along with the user identifier “U1” from the terminal 12 of the destination transmitted along with the user identifier “U1” from the terminal 12.

In Step S115, the control unit 41 of the device 40 of the vehicle V1 receives the destination data transmitted as the result of Step S114 from the control device 30 corresponding to the server 13 via the communication unit 43. The control unit 41 stores the received destination data in the storage unit 42. The control unit 41 sets the destination based on the destination data stored in the storage unit 42.

In this example, the control unit 41 of the device 40 sets the destination transmitted from the server 13 as a destination for car navigation in the application for car navigation operating in the device 40.

In Step S116, the control unit 41 of the device 40 of the vehicle V1 acquires position information of the vehicle V1 via the positioning unit 44. The control unit 41 stores the acquired position information of the vehicle V1 in the storage unit 42. The control unit 41 transmits the position information of the vehicle V1 stored in the storage unit 42 to the control device 30 corresponding to the server 13 via the communication unit 43.

In this example, the control unit 41 of the device 40 acquires two-dimensional coordinates or three-dimensional coordinates of the current position of the vehicle V1 as the position information of the vehicle V1. The control unit 41 transmits the acquired position information of the vehicle V1 along with the vehicle identifier “V1” to the server 13.

In Step S117, the control unit 31 of the control device 30 corresponding to the server 13 receives the position information of the vehicle V1 transmitted in Step S116 from the device 40 of the vehicle V1 via the communication unit 33. The control unit 31 stores the received position information of the vehicle V1 in the storage unit 32. The control unit 31 determines a route to the destination indicated along with the vehicle identifier “V1” by the first data stored in the storage unit 32 based on the position information of the vehicle V1 stored in the storage unit 32. The control unit 31 stores route data for notifying of the determined route in the storage unit 32. The control unit 31 transmits the route data stored in the storage unit 32 to the device 40 of the vehicle V1 via the communication unit 33.

In this example, the control unit 31 of the server 13 calculates a route which departs from a point corresponding to the position information of the vehicle V1 transmitted along with the vehicle identifier “V1” from the device 40 and arrives at the destination transmitted along with the user identifier “U1” from the terminal 12 with reference to map information which is stored in advance in the storage unit 32. The control unit 31 notifies the device 40 of the calculated route.

In Step S118, the control unit 41 of the device 40 of the vehicle V1 receives the route data transmitted in Step S117 from the control device 30 corresponding to the server 13 via the communication unit 43. The control unit 41 stores the received route data in the storage unit 42. The control unit 41 performs control such that guidance along the route indicated by the route data stored in the storage unit 42 is performed for the driver of the vehicle V 1. With this control, the output unit 46 of the device 40 guides the driver of the vehicle V1 for the route to the destination set by the user U1 on the screen.

In this example, the control unit 41 of the device 40 displays the route transmitted from the server 13 on the screen of the application for car navigation operating in the device 40.

The processes of Steps S116 to S118 are repeatedly performed until the vehicle V1 arrives at the destination.

As described above, in this embodiment, the communication unit 33 of the control device 30 communicates with the devices 40 of a plurality of vehicles 14 and the communication device 20 that acquires a vehicle identifier “V1” corresponding to a vehicle V1 which is boarded by a user U1 in accordance with the user U1's operation. The control unit 31 of the control device 30 receives first data for notifying of a destination set by the user U1 along with a user identifier “U1” corresponding to the user U1 from the communication device 20 via the communication unit 33. The control unit 31 receives second data for notifying of the vehicle identifier “V1” along with the user identifier “U1” from the communication device 20 via the communication unit 33. The control unit 31 transmits destination data for notifying of the destination to the device 40 of the vehicle V1 corresponding to the vehicle identifier “V1” via the communication unit 33 with reference to the first data and the second data which commonly include the user identifier “U1.”

Accordingly, according to this embodiment, information of a destination set by a user U1 can be used to set a destination in a vehicle V1 which is boarded by the user U1.

In this embodiment, the communication unit 23 of the communication device 20 communicates with the control device 30 that notifies the device 40 of the vehicle V1 boarded by the user U1 of the destination set by the user U1. The control unit 21 of the communication device 20 transmits the first data for notifying of the destination along with the user identifier “U1” corresponding to the user U1 to the control device 30 via the communication unit 23. The control unit 21 acquires the vehicle identifier “V1” corresponding to the vehicle V1 in accordance with the user U1's operation. The control unit 21 transmits the second data for notifying of the vehicle identifier “V1” along with the user identifier “U1” to the control device 30 via the communication unit 23.

Accordingly, according to this embodiment, it is possible to use information of a destination which is set by a user U1 for setting a destination in a vehicle V1 which is boarded by the user U1.

In this embodiment, the communication unit 43 of the device 40 which is used as a vehicle V1 communicates with the control device 30 that receives first data for notifying of a destination which is set by a user U1 who boarded the vehicle V1 along with a user identifier “U1” corresponding to the user. The control unit 41 of the device 40 causes the communication device 20 that transmits the first data to the control device 30 to acquire a vehicle identifier corresponding to the vehicle V1 in accordance with the user's operation of the communication device 20. The control unit 41 receives destination data for notifying of the destination, which is transmitted as a result of transmission of second data for notifying of the vehicle identifier “V1” along with the user identifier “U1” from the communication device 20 to the control device 30 and reference of the first data and the second data commonly including the user identifier “U1” by the control device 30, from the control device 30 via the communication unit 43.

Accordingly, according to this embodiment, it is possible to use information of a destination which is set by the user U1 for setting a destination in a vehicle V1 which is boarded by the user U1.

The disclosure is not limited to the above-mentioned embodiment. For example, a plurality of the blocks illustrated in the block diagrams may be combined or single blocks may be divided. A plurality of the steps illustrated in the flowcharts may not be performed in a time series in the described sequence, but may be performed in parallel or in other sequences depending on processing capabilities of devices that perform the steps or according to necessity. In addition, the embodiment can be modified without departing from the gist of the disclosure.

What is claimed is:

1. A computer-readable recording medium storing a program causing a computer to serve as a communication device comprising:
a communication unit configured to communicate with a control device that notifies a device of a vehicle which is boarded by a user of a destination which is set by the user; and
a control unit configured to transmit first data for notifying of the destination along with a user identifier corresponding to the user to the control device via the communication unit, to acquire a vehicle identifier corresponding to the vehicle in accordance with the user's operation, and to transmit second data for notifying of the vehicle identifier along with the user identifier to the control device via the communication unit.

2. The computer-readable recording medium according to claim 1, wherein the communication unit is configured to receive a beacon which is transmitted in the vehicle, and
wherein the control unit is configured to perform control such that a message for prompting the user to perform the operation is output when the beacon has been received by the communication unit.

3. The computer-readable recording medium according to claim 1, wherein the control unit is configured to acquire the vehicle identifier by performing control such that the displayed vehicle identifier is imaged in the vehicle.

4. The computer-readable recording medium according to claim 3, wherein the control unit is configured to perform control such that the vehicle identifier which is displayed as a two-dimensional code is imaged by a camera.

5. The computer-readable recording medium according to claim 1, wherein the control unit is configured to acquire the vehicle identifier by performing control such that the transmitted vehicle identifier is received in the vehicle.

6. The computer-readable recording medium according to claim 5, wherein the control unit is configured to perform control such that the vehicle identifier which is transmitted by short-range radio communication is received using a tag.

7. The computer-readable recording medium according to claim 1, wherein the control unit is configured to perform control such that guidance along a route to the destination is performed for the user based on position information of the user at least after the destination has been set and before the operation has been performed.

8. A control device comprising:
a communication unit configured to communicate with devices of a plurality of vehicles and a communication device of a user; and
a control unit configured to receive first data for notifying of a destination set by the user along with a user identifier corresponding to the user from the communication device via the communication unit, to receive second data for notifying of a vehicle identifier corresponding to a vehicle which is boarded by the user along with the user identifier from the communication device that has acquired the vehicle identifier via the communication unit, and to transmit destination data for notifying of the destination to the device of the vehicle corresponding to the vehicle identifier via the communication unit with reference to the first data and the second data which commonly include the user identifier.

9. The control device according to claim 8, wherein the control unit is configured to determine a route to the destination based on position information of the user and to transmit route data for notifying of the determined route to the communication device via the communication unit, and
wherein transmission of the route data to the communication device is performed before transmission of the destination data to the device of the vehicle.

10. A system comprising:
the control device according to claim 8; and
the communication device.

11. A system comprising:
the control device according to claim 8; and
the devices of the plurality of vehicles.

12. A non-transitory computer-readable recording medium storing a program causing a computer to serve as a device which is used for a vehicle, the device comprising:
a communication unit configured to communicate with a control device that receives first data for notifying of a destination which is set by a user who has boarded the vehicle along with a user identifier corresponding to the user; and
a control unit configured to cause a communication device that transmits the first data to the control device to acquire a vehicle identifier corresponding to the vehicle in accordance with the user's operation of the communication device and to receive destination data for notifying of the destination, which is transmitted as a result of transmission of second data for notifying of the vehicle identifier along with the user identifier from the communication device to the control device and reference of the first data and the second data commonly including the user identifier by the control device, from the control device via the communication unit.

13. The non-transitory computer-readable recording medium according to claim 12, wherein the communication unit is configured to transmit a beacon for prompting the user to perform the operation in the vehicle.

14. The non-transitory computer-readable recording medium according to claim 12, wherein the control unit is configured to cause the communication device to acquire the vehicle identifier by performing control such that the vehicle identifier is displayed.

15. The non-transitory computer-readable recording medium according to claim 14, wherein the control unit is configured to perform control such that the vehicle identifier is displayed as a two-dimensional code on a display.

16. The non-transitory computer-readable recording medium according to claim 12, wherein the control unit is configured to cause the communication device to acquire the vehicle identifier by performing control such that the vehicle identifier is transmitted.

17. The non-transitory computer-readable recording medium according to claim 16, wherein the control unit is configured to perform control such that the vehicle identifier is transmitted from a writer by short-range radio communication.

18. The non-transitory computer-readable recording medium according to claim 12, wherein the control unit is configured to perform control such that guidance along a route to the destination indicated by the received destination data is performed for a driver of the vehicle based on position information of the vehicle.

19. A device that performs a process corresponding to the program stored in the non-transitory computer-readable recording medium according to claim 12.

20. A vehicle in which the device according to claim 19 is mounted.
